(19) United States
(12) Patent Application Publication
(10) Pub. No.: US 2025/0238953 A1
(43) Pub. Date: Jul. 24, 2025

(54) LOCALIZATION FOR AERIAL SYSTEMS IN GPS DENIED ENVIRONMENTS

(71) Applicant: U.S. Army DEVCOM, Army Research Laboratory, Adelphi, MD (US)

(72) Inventors: Bethany L. Allik, Baltimore, MD (US); Cory I. Miller, Baltimore, MD (US); Nathan L. Schomer, Corvallis, OR (US)

(21) Appl. No.: 18/419,595

(22) Filed: Jan. 23, 2024

(51) Int. Cl. G06T 7/73; G06V 10/42; G06V 20/17

(52) U.S. Cl. CPC G06T 7/74; G06V 10/42; G06V 20/17; G06T 2207/10048; G06T 2207/20084

(57) ABSTRACT

A high-altitude platform and method for in-flight navigation, the platform comprising a ground-facing camera and a computing device including a memory and a processor, the memory storing instructions which when processed cause the computing device to perform a position determination method, comprising: acquiring one or more images from the ground-facing imaging device; retrieving, from an image dataset associated with a trained model, a plurality images associated with an area of interest; processing, using an image comparator, the acquired one or more images and the retrieved images associated with terrain of interest to derive therefrom respective acquired image feature sets; using a loss function, comparing each acquired image feature set to each retrieved image feature set to identify for each acquired image a corresponding matching retrieved image; using the matched image and the optical characteristics of the ground-facing camera, determining the position of the platform.

### GOVERNMENT INTEREST

The invention described herein may be manufactured and used by or for the Government of the United States for all governmental purposes without the payment of any royalty.

### FIELD OF THE DISCLOSURE

The present disclosure relates generally to navigation using localized data within a GPS denied environment.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Most aerial systems rely on GPS for navigation. Much work has been done to enable navigation without GPS, however these options are usually intended for terrestrial applications operating in an urban canyon or defense systems operating in contested environments. In these cases, the systems may use visual cues or mapping data for localizing themselves within the global frame. Few options remain for GPS denied navigation for high flying vehicles, where visual cues are far away. However, high flying vehicles have advantages over terrestrial applications with respect to GPS, such as improved line of sight to many satellites as obstacles are limited to clouds which are penetrable by GPS signals, as well as being harder to interfere with because they are farther away from adversarial ground system.

However, there is a need to provide GPS alternatives to high-flying aerial systems for robust guidance, navigation, and control in difficult and contested environments. For example, GPS alternatives would be advantageous in the presence of advanced signal jammers that limit GPS availability over large regions. Another scenario to consider is systems in extreme environments, such as high-G shocks, where GPS solutions may be difficult or impossible to recover due to clock, RF, and dynamic challenges, resulting loss of navigation measurements until requisition occurs. GPS is a technology integral to the success of many modern navigation systems. However, there is a need to make autonomous aerial systems more robust by decreasing reliance to the outside world. This includes communications with both ground systems and satellites, as every dependency to external sources weakens the system and makes it vulnerable to failure. A fully self-reliant and passive operational mode is especially desirable in an actively contested domain.

It is known to use a downward facing camera to capture in-flight imagery and match the captured imagery to a 3D surface model and derive position/location data thereby. The known methods rely upon frequent database updates, in-flight altitude information and little to no cloud cover.

### SUMMARY OF THE INVENTION

Various deficiencies in the prior art are addressed by apparatus and methods providing localization for high flying systems over sparse terrain, wherein a neural network such as a twin network architecture is trained for each area of interest using relevant imagery and other data retrieved over a long period of time across season changes, heavy cloud cover, and the like.

Various embodiments include a high-altitude platform and method therefor for in-flight navigation, the platform comprising a ground-facing camera and a computing device including a memory and a processor, the memory storing instructions which when processed cause the computing device to perform a position determination method, comprising: acquiring one or more images from the ground-facing imaging device; retrieving, from an image dataset associated with a trained model, a plurality images associated with an area of interest; processing, using an image comparator, the acquired one or more images and the retrieved images associated with terrain of interest to derive therefrom respective acquired image feature sets; using a loss function, comparing each acquired image feature set to each retrieved image feature set to identify for each acquired image a corresponding matching retrieved image; using the matched image and the optical characteristics of the ground-facing camera, determining the position of the platform.

The image comparator may comprise a neural network. The image comparator may comprise first and second convolutional neural networks (CNNs), each operating in a substantially similar manner to process, respectively, the acquired one or more images and the retrieved images associated with terrain of interest.

The ground-facing imaging device may be configured to acquire images in two spectral regions; wherein the retrieved images associated with terrain of interest comprise images associated with each of a first spectral region reference map and a second spectral region reference map; each acquired image feature set associated with the first spectral region is compared to each retrieved image feature set from the first spectral region reference map; and each acquired image feature set associated with the second spectral region is compared to each retrieved image feature set from the second spectral region reference map.

Determining the position of the platform may be performed using the matched image and the optical characteristics of the ground-facing camera for each of the two spectral regions, such as via an average of determined positions of the platform performed using the matched image and the optical characteristics of the ground-facing camera for each of the two spectral regions.

The first and second spectral regions may comprise respective portions of visible, infrared, color-infrared, and ultraviolet spectral regions. The first and second spectral regions may comprise respective portions of visible, infrared, color-infrared, ultraviolet, and radar related (e.g., radar sensing or radar mased measurement) spectral regions.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 graphically illustrates pre-flight training data suitable for use in the various embodiments;

FIG. 2 illustrates a method of localization suitable for use in an airborne platform:

FIG. 3 illustrates an exemplary inflight matching and localization method suitable for use in the various embodiments;

FIG. 4 depicts a flow diagram of an image similarity determination method according to an embodiment;

FIG. 5 depicts a block diagram of an exemplary twin network configured for use in the various embodiments;

FIGS. 6A and 6C graphically illustrate a distribution of inference outputs for a first exemplary network over large samples of positive image pairs;

FIGS. 6B and 6D graphically illustrate a distribution of inference outputs for the first exemplary network over large samples of negative image pairs;

FIG. 7A graphically illustrates an exemplary projection of true camera state x onto the camera map;

FIG. 7B graphically illustrates an exemplary projection of current camera state estimate x onto the reference map;

FIG. 8A illustrates exemplary unscented projections of camera state estimate onto the reference map;

FIG. 8B illustrates exemplary Grid-Search query locations sampled at a fixed interval within the 30 projection area of the camera state estimate; and

FIGS. 9A-11C illustrate various images and representative processing thereof useful in understanding the embodiments.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

Using a downward facing camera to capture in-flight imagery and match the captured imagery to a 3D surface model and derive position/location data thereby is known, though such systems rely upon frequent database updates, in-flight altitude information and little to no cloud cover.

The various embodiments improve upon the prior art by avoiding a need for frequent database updates, in-flight altitude information, and little to no cloud cover by using a dataset that has been extensively trained across multiple scenarios, conditions, seasons, times of day, and so on to provide a robust mapping capability suitable for use by an airborne platform configured to, illustratively, capture downward looking in-flight imagery and match the captured imagery to a 3D surface model based upon the dataset and derive thereby position/location information. The various embodiments advantageously provide a low-cost inertial measurement unit (IMU) capable of excellent accuracy with smaller cameras or smaller field of view (FOV) imaging devices.

Various embodiments contemplate a method and system for navigation of aerial vehicles in GPS denied or degraded environments using an onboard imager and previously obtained imagery. The method is completely passive and requires no in-flight updates, making it a robust navigation aide for GPS denied or degraded environments. The various embodiments rely upon a data-driven approach to find robust features in landscape terrain and use such features for updating navigation information.

The onboard imager may comprise a downward facing camera generating images that are matched to stored onboard imagery to obtain thereby navigation solutions. The matching strategy is a learned process from numerous pulled data samples associated with terrain or geographic areas of interest, preferably including feature data of the terrain/area obtained over long periods of time including seasonal changes, changing atmospherics, times of day, and so on. This robustness allows for navigation across multiple terrains, weather conditions, times of day, and so on.

The images retrieved via an airborne platform's downward facing imager may comprise image data gathered in optical spectral regions, or spectral regions above or below optical wavelengths. In various embodiments, the imager generates images using multiple spectral regions (e.g., visible light, infrared regions, color-infrared regions, ultraviolet regions), using radar related regions, lidar related regions, and so on.

Various embodiments are adapted to maintaining guidance of airborne platforms and the like in a GPS denied environment condition for long range precision fires. The various embodiments may be beneficially adapted to other platforms where navigation error may be substantial, such as UAVs.

Various embodiments utilize pre-flight training. For example, exhaustive data acquisition and pre-flight processing may be used to greatly speed up the onboard processing of imagery relevant to a missions, as well as to increase the success rate for obtaining global positioning updates when there is no access to GPS.

Various embodiments provide a method and system for navigation of aerial vehicles in GPS denied environments using an onboard imager and previously obtained satellite imagery and, optionally, other imagery

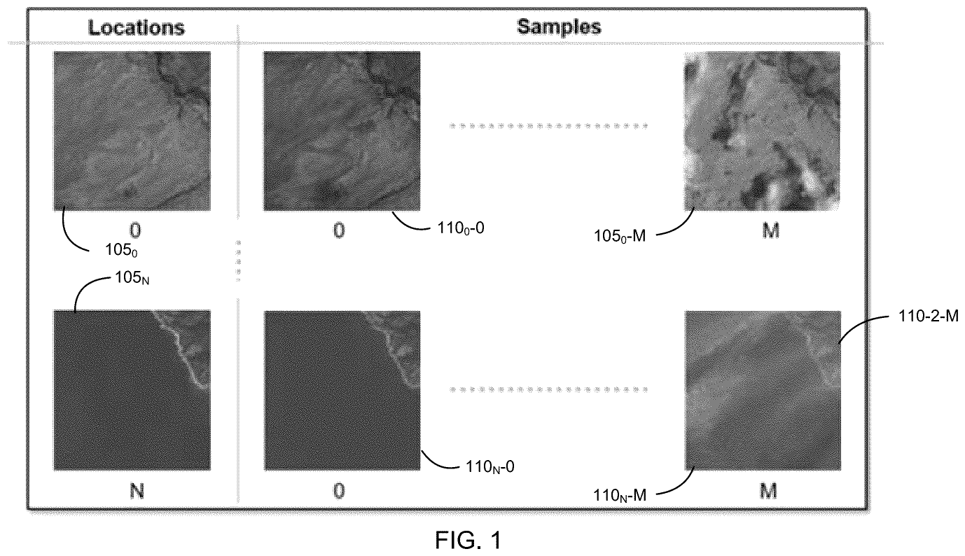

FIG. 1 graphically illustrates pre-flight training data suitable for use in the various embodiments. Specifically, FIG. 1 depicts a number of locations 105 (illustratively locations 105₀ through 105_{N}) wherein each location has associated with it a respective plurality (M) of satellite images captured over time (i.e., 110_{X}-0 through 110_{X}-M), which images are captures by satellite or other means over a long period of time and under various weather conditions, atmospheric effects, times of day, seasons, and so on.

The various embodiments contemplate a preprocessing step using a large number of images associated with one or more areas of interest, such as provided in FIG. 1. This preprocessing includes pre-flight training using the captured images to learn consistent features across the aforementioned effects for the locations of interest. The output of the learning processes results in an aerial geo-matcher. The aerial vehicle computer contains few satellite imagery tiles uploaded prior to flight, covering the predicted flight path. Connected to the onboard computer is a downward facing camera.

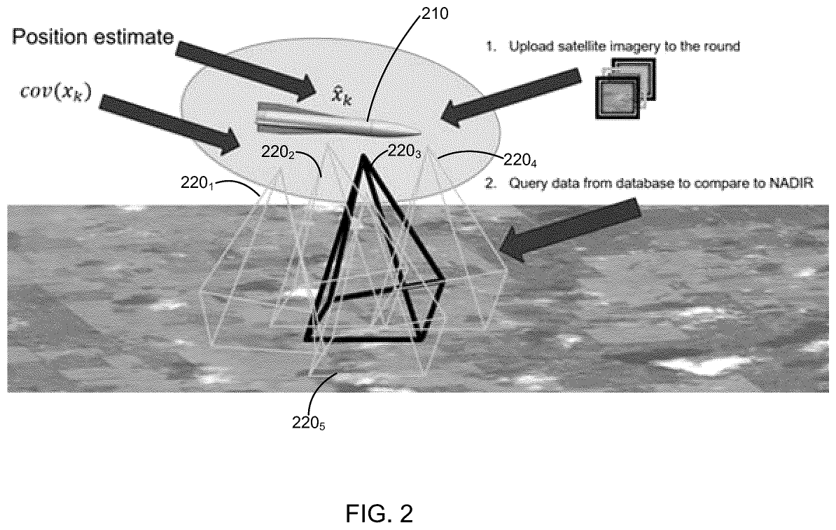

FIG. 2 illustrates a method of localization suitable for use in an airborne platform. Specifically, an airborne platform 210 is depicted a capturing a plurality of surface images 220 via a downward facing camera. The captured imagery is matched to image information within the preprocessed dataset to identify a location using a geo-matcher, wherein the matching results are further processed to obtain a navigation solution.

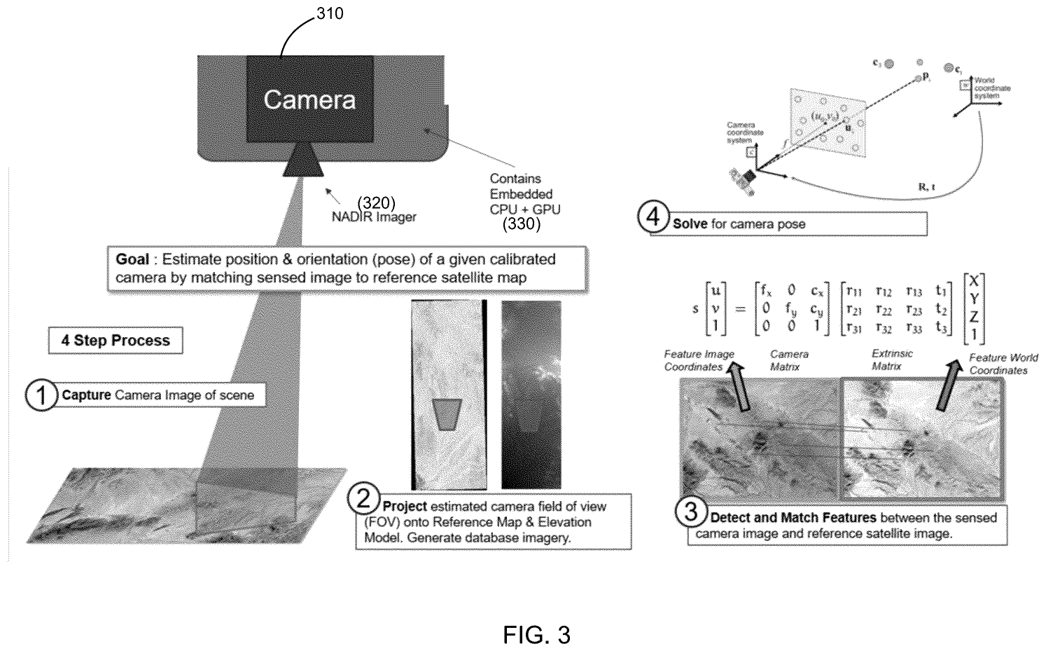

FIG. 3 illustrates an exemplary inflight matching and localization method suitable for use in the various embodiments. To accomplish this, an airborne platform 210 such as depicted in FIG. 2 includes a camera 310 configured to acquire imagery for processing via on-board computing devices 330, the imagery received via one or more downward facing imagers 320 such as an optical spectrum imager NADIR imager. It is noted that non-optical spectrum imagers and processing are also contemplated in various embodiments. That is, the imager 320 may acquire for processing image data associated with one or more spectral regions or combinations thereof, which acquired image data is processed or compared to on-board imaging data such as one or more imaging maps, wherein each imaging map has been previously generated or constructed using compatible imaging data (i.e., imaging data also associated with the one or more spectral regions or combinations thereof).

On-board computing devices 330 may include processors, memory, input/output devices and the like, and be used to perform various functions depicted and described herein. On-board computing devices 330 and may be implemented as hardware or a combination of software and hardware, such as by using one or more general-purpose computers, central processing units (CPUs), graphics processing units (GPUs), application specific integrated circuits (ASIC) s, or any other hardware equivalents or combinations thereof.

In various embodiments, computer instructions associated with functions, processes, methods and/or techniques described herein are loaded into a memory and executed by processor(s). Thus, any of the various functions, elements and/or modules described herein, or portions thereof, may be implemented as a computer program product wherein computer instructions, when processed by a computing device, adapt the operation of the computing device such that the functions, processes, methods and/or techniques described herein are invoked or otherwise provided. Instructions for invoking the inventive methods may be stored in tangible and non-transitory computer readable medium such as fixed or removable media or memory or stored within a memory within a computing device operating according to the instructions.

Specifically, in various embodiments an in-flight processing goal is to estimate the position and orientation (pose) of a given calibrated camera by matching sensed images to a reference satellite map. At a first step, an image is captured by a downward facing camera/imager 310/320 of the airborne platform 210. At a second step, the estimated camera field of view (FOV) is projected onto a reference map and elevation model to identify thereby relevant database imagery. At a third step, detection of features and matching of those features between the sensed camera image and the reference satellite image(s) is performed so as to identify the relevant terrestrial location associated with the captured image. At a fourth step, a solution for camera pose is performed so as to provide sufficient coordinate information to identify the position/location of the aerial platform with respect to the relevant terrestrial location. This process may be continually performed for multiple captured images.

Various embodiments contemplate that the use of a downward facing camera (NADIR camera) may also comprise a multi-spectral camera/imager and/or a synthetic aperture radar (SAR) or other radar device. In this manner, the various embodiments extend system use to all weather conditions, as well as day/night scenarios. Further, the NADIR camera and database imagery may contain various amounts and varieties of spectral and SAR data and the above-described matching steps may be modified to occur across these additional domains. This cross-domain matching may be useful when, for example, available satellite data does not utilize the same spectrum as the assets NADIR sensor.

A fully self-reliant and passive operational mode is especially desirable in an actively contested domain. Typically, GPS solutions update one to five times per second. For autonomous systems, this update is crucial for maintaining accurate navigation by reducing on-board estimator drift. The drift is a product of inertial measurement unit (IMU) update steps performed by a navigation filter, in which accelerometer, gyroscope, magnetometer, and other sensor measurements are integrated to propagate state estimates. Typically, inertial sensors are subject to bias and scale-factor uncertainties that may deviate over time and temperature. Therefore, raw integration of these noisy sensor signals cause a bias in the position estimator. The quality, expense, and size of the IMU are all correlated to the rate of position estimate drift resulting from integration. State estimators such as the Kalman filter often track these biases to account for them in real-time and attempt to limit their impact on position error drift. In the case of error state Kalman filter, the error is tracked and grows unbounded without a global positioning measurement. When a global positioning measurement arrives, this error is ‘reset’, and the error will grow again until the next positioning measurement occurs.

Various embodiments provide a method and system for navigation of aerial vehicles in GPS denied environments using onboard imager and previously obtained satellite imagery. The processes and method includes a prior training stage before flight, when large quantities of satellite imagery, with varying atmospheric effects, seasonal effects, over a long durations of time are pulled to a computer memory. Sub sequentially the imagery is used to learn consistent features across the aforementioned effects. The output of the learning processes results in an aerial geo-matcher. The aerial vehicle computer contains few satellite imagery tiles uploaded prior to flight, covering the predicted flight path. Connected to the onboard computer is a downward facing camera. Using the onboard navigation solution obtained from the flight vehicles computer a search area on the onboard satellite imagery is obtained. Camera obtained imagery is matched using the geo-matcher, matching results are processed to obtain a navigation solution.

One aspect of the various embodiments is pre-flight training, wherein exhaustive data acquisition and pre-flight processing greatly speeds up onboard processing and increases the success rate for obtaining global positioning updates when there is no access to GPS.

Various embodiments enable navigation in GPS denied environments especially useful for high-flying systems operating over sparse terrain.

Methods and apparatus according to various embodiments comprise a machine learning based approach using a twin network architecture to enable scene recognition from a NADIR imager (i.e., an imager pointing directly down from an airborne platform so as to capture imagery of the ground directly under the airborne platform). These embodiments find utility in a number of use cases, such as navigation of UAVs, navigation of satellites, navigation of weapons systems, surveillance, search, and rescue, and so on.

To solve the issue of providing a global positioning measurement for high flying aerial systems in GPS-denied domains various embodiments provide an approach using an onboard, NADIR imager. The images from this camera are compared to query images from the probable aerial location, using a stored reference satellite map. These query images are found by using navigation error estimates to project the areas on the ground that the vehicle is likely to be observing. Alternatively, in the condition that the navigation state estimator is uninitialized or diverged, one may also consider a “lost robot problem,” where all areas of the domain are searched. This approach however can be very computationally expensive and unable to meet update rate requirements necessary to effectively limit the aforementioned IMU navigation error drift. The goal here is to leverage the onboard estimator to narrow the search space. The search space considered here could be very large if the last global positioning measurement was obtained a long time ago, or the onboard sensor is low-quality. For our approach, we propose binning of the probable aerial location, this would allow a speed up in processing by lowing the number of matches needed, at the expensive of potentially lower precision and accuracy in the resultant navigation solution. Once an initial position estimate is obtained more precise searches in the region may be done to improve the results.

In exemplary embodiments, the matching approach used herein is via a twin neural network, which is forms a “one shot learning” algorithm in that at the time of inference only one input image is necessary to find a match within a given test set, even though no representation of this input image has been encountered by the neural network during training. For example, an ideal twin neural network will be able to correctly match an input representation of the letter ‘Z’ to test representation of the letter ‘Z’, even though at the time of training the network was only has only ever been presented with representations of letters ‘A’ through ‘W’. This is because the twin network is not finding classifications like the standard convolution network but instead learning to create a similarity score between two given inputs. In this sense, the twin neural network is learning the matching process itself and learned how to perform a “One shot” detection. The method leverages the twin network by treating the input camera image captured by the aerial vehicle as the “One Shot” input, and reference map query locations & resultant projections as a query image set and use the match output results for localization & navigation. In various other embodiments, neural networks types and/or architectures other than the twin neural network discussed herein are used.

Various embodiments contemplate a twin network explicitly trained and leveraged for the purposes of navigation of very high-flying autonomous vehicles, and providing a solution which is robust to macro level image disparities, including but not limited to the potential for cloud cover, seasonal variations, human development and influences, significant shadows, and other temporal effects. A machine learning based approach is used for a robust solution across all terrain types, and to provide improved navigation information when performance of traditional methods is degraded.

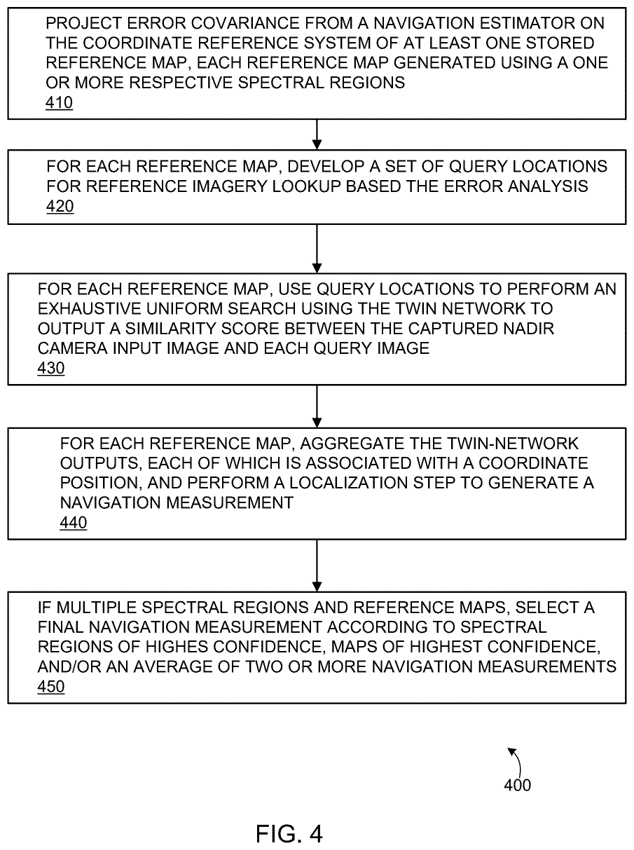

FIG. 4 depicts a flow diagram of an image similarity determination method according to an embodiment. Specifically, the method 400 of FIG. 4 may be implemented in an airborne platform or UAV to provide rapid estimation of similarities between images, such as nadir camera acquired images and dataset-stored images.

At step 410, the method projects the error covariance from a navigation estimator on the coordinate reference system of at least one stored reference map, wherein each of the at least one stored reference maps is associated with a respective one or more spectral regions. The spectral regions may comprise, alone or in any combination, a visible/optical spectral region or portion thereof, an infrared or color-infrared spectral region or portion thereof, a radar-related spectral region or portion thereof, or some other electromagnetic spectrum region(s) or portion(s) thereof, and so on depending upon the availability of corresponding image data or image maps, and NADIR camera capability.

At step 420, for each reference map of interest (i.e., each reference map associated with a particular one or more spectral regions of interest) the method develops a set of query locations for reference imagery lookup based the error analysis.

At step 430, for each reference map of interest the method uses query locations to perform an exhaustive uniform search of the reference map, using the twin network to output a similarity score between the captured camera input image and each query image.

At step 440, for each reference map of interest the method aggregates the twin-network outputs, each of which is associated with a coordinate position, and perform a localization step to generate a navigation measurement.

At optional step 450, if multiple spectral regions and/or reference maps are used, then a final navigation measurement may be selected according to the spectral region or map of highest reliability or confidence level (e.g., more or better data, better imager resolution or accuracy, etc.), an averaging of at least some of the navigations measurements generated at step 440 (e.g., using image data associated with at least two spectral regions or portions thereof), a weighted averaging of at least some of the navigations measurements generated at step 440 (e.g., weighted in accordance with reliability or confidence level), and/or some other suitable mechanism.

The method 400 is adapted to implement localized navigation such as when an aerial system has substantial navigation error and may be operating in featureless terrain, for example desert with no buildings or roads. As discussed in more detail below, a neural network architecture is provided that is able to recognize subtle, non-manmade terrain changes.

Training Dataset. Various embodiments utilize a training dataset generated to support the navigation goals described herein, such as real-time navigation with discretization of 2D reference map data to generate query images.

As noted, various embodiments are directed to a navigation aide for high flying systems with substantial error in the position estimate. Because the intended platform is at high altitudes, atmospheric effects and cloud cover must be considered. The system needs to be robust to successful queries of the reference image database even when the query image has substantial cloud cover. The robust neural network would be able to find image matches even when some ‘key’ features, (buildings, roads, unique terrain features) are occluded. That being said we include heavy cloud cover over the entire training dataset. Also, data is pulled for training over an entire calendar year to obtain a diverse dataset that will include seasonal changes (fall, winter, spring, summer), along with tide changes that may occur near bodies of water.

Random locations are drawn from locations in the southwestern United States and Mexico, including coastal data in California, USA and Northwestern, Mexico. Data pulled from the satellites may have up to 75 percent cloud cover.

All images are transformed prior to network input for both training and testing. At a minimum, the 500×500 images at a resolution of 30 meters per pixel, are center-cropped to match the input size of the network. For the original architecture, this size is 170×170 while the new network architecture uses an input size of 224×224. To achieve partial overlap between image pairs, the original 500×500 images are padded along one or more sides. This shifts the center of the image such that when a center crop is taken from each image, the centers are offset by a certain amount. We experimented with additional image transformations such as normalization, affine transforms, and color jitter. These transforms are applied to the original 500×500 images before center crops are taken.

The training data is obtained from, illustratively, three sources (though more or fewer or different sources may be used); namely, Landsat, Sentinel, and Digital Globe.

Landsat. The Landsat satellites, first being placed in orbit in 1972, have produced the longest record of the Earth land surface [31]. Landsat 8 data is conveniently located through Amazon S3, where imagery is continuously updated every day free of charge. Landsat 8 has 11 bands, wherein red, green and blue sensors are pulled and concatenated to build the training and test images. Landsat imagery has a resolution of 30 meters/pixel.

Sentinel. The Sentinel-2 LIC data has been available since June 2015. Like Landsat 8, the data is conveniently located on Amazon S3 where it can be easily pulled from. The Sentinel dataset contains 13 bands, like in Landsat the visible bands are pulled separately and concatenate locally to generate the training and testing set. This dataset has higher resolution of 10 meters/pixel.

Digital Globe. High resolution imagery from DigitalGlobe's “WorldView” satellites, now owned by Maxar Technologies, has been available since 1999. These datasets can span multiple years, bands, seasons, and is useful for camera simulations that can span multiple altitude regimes. This dataset has higher resolution of greater than 1 meters/pixel.

Training Objectives. The objective is to train a model to identify similarities between a test image and query image. In practice, the query image is pulled from a database satellite reference image stored a priori in accordance with the expected operational area (e.g., expected overflight terrain) of the autonomous vehicle. Our aim is to train a network that outputs a value from 0 to 1, depending on whether or not the test image and query image represent a view of the same global position. This problem can be framed in two ways-either as a binary classification problem or a regression task. Models were trained for both scenarios using images pairs with varying overlap between 75% and 100%. To train the network as a binary classifier, image pairs for training were labeled with either a 0 or 1 depending on if they represented ground views with <75% or >75% overlap, respectively. For the regression task, the network was trained with image pairs labeled with continuous labels between 0 and 1 such that the label equaled the percent overlap between the two images.

Ideally, the network would output 1.0 only when the test image and query image represented the exact same location. In practice, this is infeasible due to imager differences and other visual perturbations. Instead, the network is trained with varying overlap between the test and query image. For example, in the case of the binary classifier trained with 75%-100% overlap between image pairs using an output decision boundary of 0.5, the network could be used to build a binary result map across multiple tiles of adjacent query imagery. The centroid of the binary valued area could then be used as a localization measurement. The robustness of this strategy increases more if the regression model is used and tile-size is reduced. It is expected that instead of having a binary result heat map, the continuous output values of the regression model could be used to construct a continuous heat map with contours and gradients that could be used to more accurately predict the location of the test image.

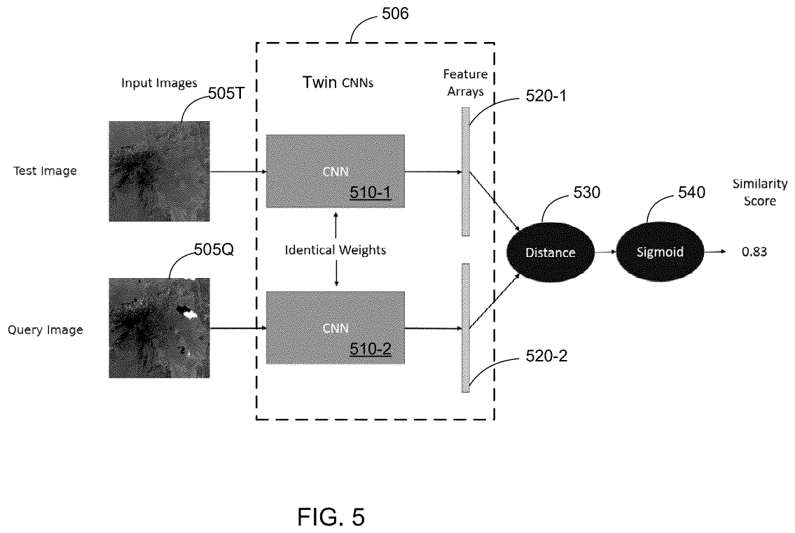

Twin Network. FIG. 5 depicts a block diagram of an exemplary twin network configured for use in the various embodiments. Specifically, an image comparator 506 is configured to compare imagery from one or more spectral regions as discussed herein, such as comparing each of one or more images received from a downward facing NADIR imager 320 of an airborne platform 210 to corresponding images within a reference satellite map or image database preferably stored within computing/storage devices on the airborne platform 210 so as to characterize image distance and other parameters useful in the location and perspective of the airborne platform 210 with respect to the terrain.

As depicted in FIG. 5, the image comparator 506 comprises a neural network such as a twin neural network wherein a first or test image 505T is provided to a first convolutional neural network (CNN) 510-1 while a second or query image 505Q is provided to a second CNN 510-2. The first and second CNNs 510-1, 510-2 are substantially identical (common) in operation (illustratively VGG16, VGG19, and the like) and configured to produce respective one-dimensional feature arrays 520-1, 520-2 in response to their respective processed input images. These feature arrays encode features extracted by each path of the twin network.

The outputs of the image comparator 506, illustratively the feature arrays of received input images 505, are passed to a loss function 530 which calculates the distance between the features (i.e., compares the feature sets to determine how similar they are). Exemplary satellite imagery having an input size of 170×170 pixels may be used. Other sizes of imagery may also be used. The twin network 500 may be used to match images from a nadir camera on a UAV to a constrained region of satellite imagery. Next, a similarity score is generated 540 such as via a sigmoid similarity function. If the similarity score is below a threshold level, then the test image and query image are said to be matched.

The above-described matching process may be performed for each of a plurality of images acquired via a ground facing camera by comparing each of the acquired images to a number of images retrieved from a dataset of images associated with an area or region of interest. In this manner, image matches may be determined and the geometry associated with the camera and matching image may be reconciled to determine thereby a location/position of the airborne platform or UAV.

Network Performance. The statistics of exemplary network performance on test imagery after training for two different networks will be discussed here and referenced below. A first network was constructed with the original network architecture as described in the previous section and was trained using DigitalGlobe imagery of size 170×170 sampled from approximately two thousand randomly distributed locations restricted to southwest Arizona. The goal of this network and training was to use a smaller region to demonstrate the ability of the twin network to learn how to discriminate imagery and create a network suitable for use as navigation source. A second network was constructed with the modified twin network architecture utilizing VGG19 and utilized larger 224×224 DigitalGlobe imagery sampled from an expanded search area covering a significant portion of the continental United States, albeit with potential cloud cover restricted to less than five percent. The goal of this network was to generalize the applicability of the twin network to multiple terrains.

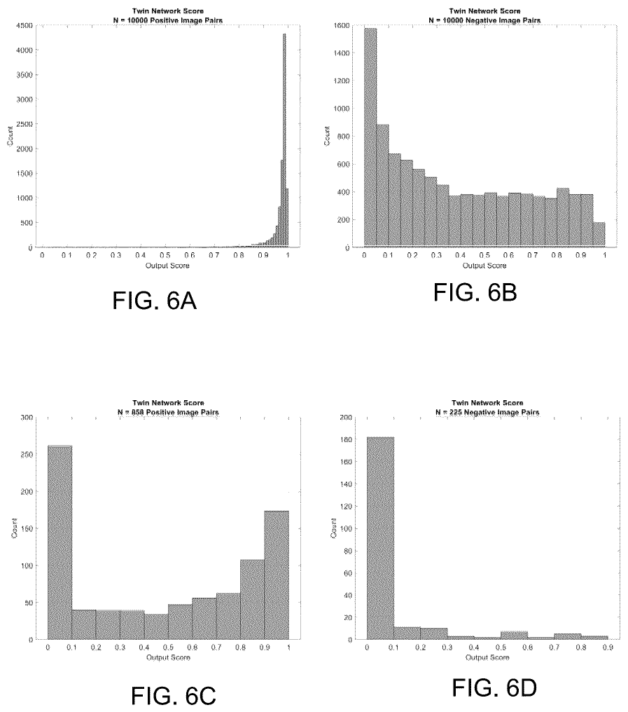

FIGS. 6A and 6C graphically illustrate a distribution of inference outputs for a first exemplary network over a large sample of positive image pairs (two different images sampled from the same location). FIGS. 6B and 6D graphically illustrate a distribution of inference outputs for the first exemplary network over a large sample of negative image pairs (i.e., two different images sampled from non-overlapping locations). The lack of a uniform histogram indicates that the network is not guessing, and the network has learned during training. A strongly skewed histogram towards inference outputs near one for positive image pairs indicates a strong ability for the twin network to correctly identify two images from like-locations. The output histogram for negative image pairs is less weighted towards zero, indicating more difficulty in correctly predicting that two disparate images of desert scenery do not correspond to the same location, which is unsurprising given the difficulty of the problem.

The distribution of inference outputs for the second network over a large sample of positive image pairs and negative image pairs is shown in FIG. 2. This networks shows a greater ability to reject negative image pairs, which is unsurprising given the greater variety of possible scenes presented to the network but is less confident in predicting positive image pairs. Correct prediction of positive image pairs is still clearly performed better than random guess, indicating the network is learning, however a significant number of false-negatives exist at or near zero output. Further analysis is still needed at this time to investigate the primary causes of these false-negatives and if an architectural or training changes can be performed to improve results further.

Navigation. The disclosed neural network method is capable of matching two overlapping satellite images, and rejecting two non-overlapping satellite images. The following section will discuss how this capability can be leveraged to generate useful navigation information in the presence of camera position state uncertainty in high altitude flight. For simplicity it is assumed that camera altitude and heading are known without error and camera attitude is negligible, thus the camera image center directly corresponds to the camera nadir position.

Problem Setup/Parameters. Define true camera position state x as the camera nadir XY position on the local coordinate reference system:

$$x = {[ \begin{matrix}X \\ Y\end{matrix} ]}_{CRS}$$

Define the current camera position state estimate x as:

$$\hat{x} = x - e$$

where e is an unknown error. For the purposes of the following discussion it is assumed that the current state estimate covariance σ is known and accurate.

Furthermore, it is assumed that camera focal length is known and accurate, camera principal point is centered in the imager field of view, and camera skew and distortion parameters are negligible.

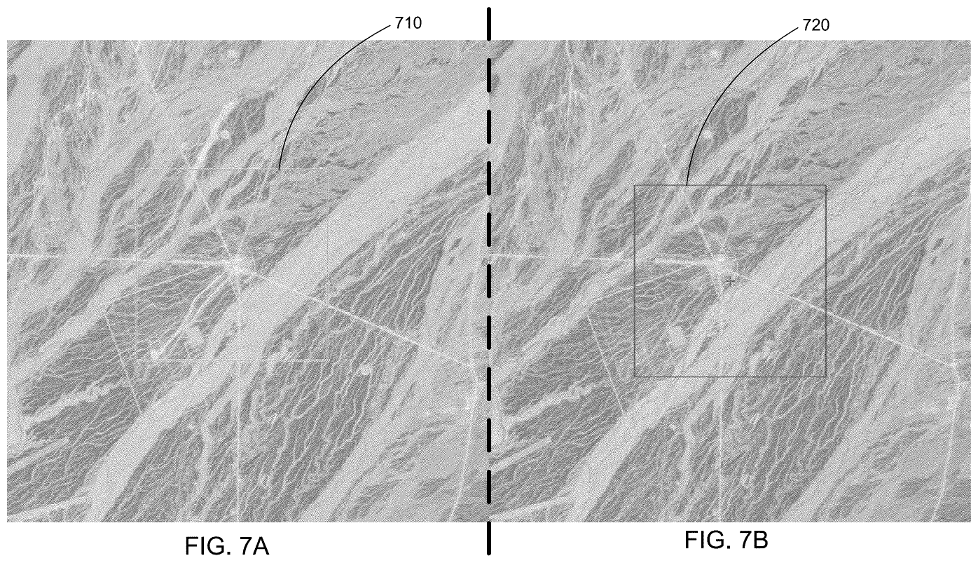

FIG. 7A graphically illustrates an exemplary projection of true camera state x onto the camera map, and FIG. 7B graphically illustrates an exemplary projection of current camera state estimate x onto the reference map. Specifically, FIG. 7A depicts an image having a projection delineated theron of the true camera state onto the simulated current environment, while FIG. 7B depicts an image having a projection delineated theron of the estimated camera state onto the stored reference satellite map.

FIG. 7A shows the projection of the true camera state x onto what is denoted herein as the “camera map”. This represents the projection of the unknown true state onto the current scene, i.e. the field of view that is captured by the imager and used as the test input for all subsequent twin-network inferences. FIG. 7B shows the projection of the current camera state estimate x onto what will be referred to as the “reference map” that defines an expected field of view within a stored satellite reference database. The objective for navigation is to utilize the twin-network to forward the input camera image with various query locations within the reference map and subsequently generate a measured location y within the reference map such that y=x.

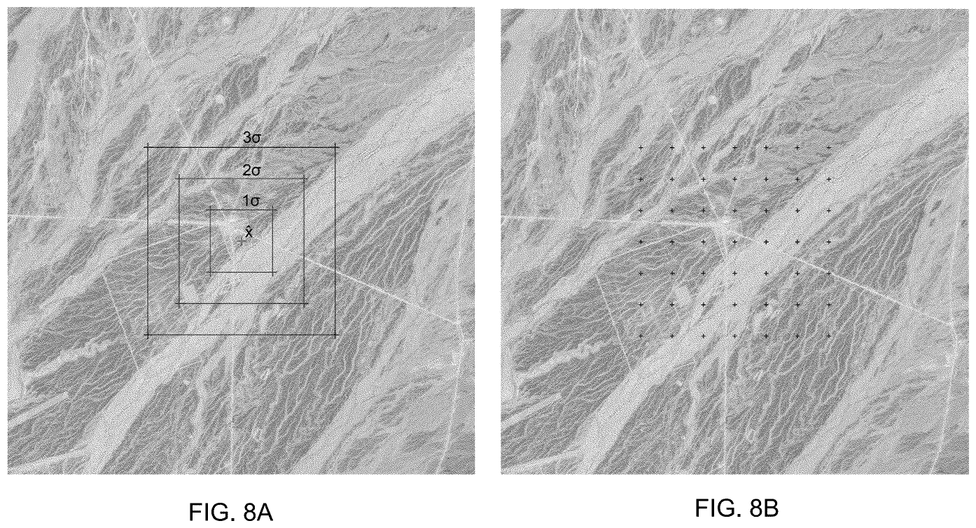

FIG. 8A illustrates exemplary unscented projections of camera state estimate onto the reference map. Assuming a normally distributed state error with Gaussian distribution and known covariance, there exists a 99.7% probability that the unknown true camera nadir position lies within the 30 region. FIG. 8B illustrates exemplary Grid-Search query locations sampled at a fixed interval within the 30 projection area of the camera state estimate. For easier visualization, only every tenth query location is shown on the reference map.

In a method according to one embodiment, to generate query locations within the reference an exhaustive grid-search methodology is used, the methodology being centered about current state estimate nadir position and bounded and sampled in a deterministic manner to ensure an expected probability of overlapping with the test image's field of view. At each query location a new camera projection is performed into the reference map to generate a new query image, and these are used for twin-network inference with the original camera test image. The bounds of the grid-search area is determined using an unscented transform to project the 30 extents of the distribution of x onto the reference map, as shown in FIG. 8A. Since non-zero attitude orientations are not being considered, this bounded area is equivalent to possible projected locations of the camera center field of view and likewise the camera nadir position. Using the extents of the 30 unscented transform of x ensures that with 99.7% probability that the true camera location x lies within this bound.

Next, sample query points within the reference map are defined in a fixed grid of even spacing within this bounded region, as shown in FIG. 8B. Each of these query sample points represents a point of camera re-projection onto the reference map, and subsequently a “query” input for twin-network inference. Inference output for each query location are then stored in a navigation result map that is registered within the same world coordinates of the reference imagery. The inference result is stored in the result map over an area of maximal size without overlapping with adjacent query locations. The result at the end of processing all query locations within the search-area is a heatmap as exemplified by FIG. 8 (a). The coarse or fine granularity of this result map can be controlled by the spacing of the query sample points within the reference map search area, in order to balance execution time versus potential measurement precision.

The last step for extraction of useful navigation information is to process the result map to generate location measurement y. This step is denoted herein as localization. Many methods can be taken to perform this localization, including peak detection, clustering, averaging, and maximal probability approaches. We consider two primary methods of localization within the result heatmap, the simplest being peak detection, and a slightly more robust method using moments. For peak detection, the measurement y_{xy} is taken as the pixel location in the result heatmap of maximal twin-network inference output, or in other words, maximal similarity between test and query inputs. Pixel coordinates are then transformed to world coordinates to define y using the inverse geo-transform of the reference map. This approach is fast, and potentially very accurate when used with unique scenes with well-defined maximal response when the reference map is queried near the true nadir camera location. However, the approached is fundamentally limited in precision to the size of the query sample grid step-size, and a well-defined and unique peak output may not exist within the result map. A more robust localization method is to calculate the moments of the result map, and then take y_{xy} as the center of mass of the result map. This method can be highly precise when the result map is symmetric about the true camera location and query responses far from the true camera location are suppressed, which is the ideal output of a twin-network trained with continuous labels.

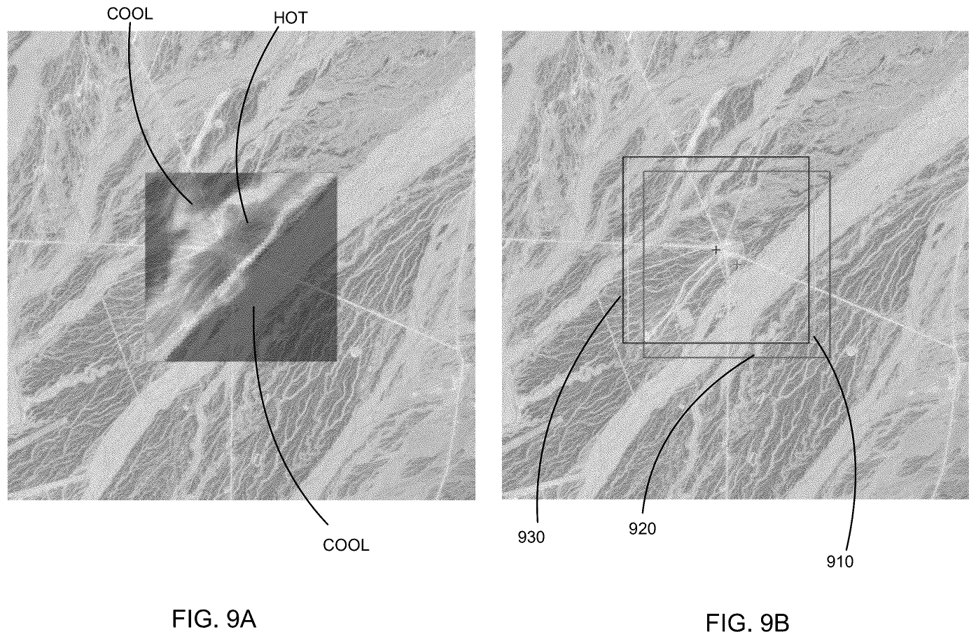

FIGS. 9A-9B illustrate twin-network output over search area & resulting navigation measurement. Specifically, FIG. 9A illustrates Twin-Network inference output at query locations, visualized as an artificially shaded heatmap overlayed on a camera map. It is clear from the resultant heatmap that areas near the true camera location (HOT) are higher responding, as well as locations with similar distinct terrain features. FIG. 9B illustrates resulting navigation measurement & error as visualized on the camera map. True camera projection is shown in a first region 910, while state estimate camera projection is shown in a second region 920, and projection from the localization measurement is shown in a third region 930.

### Example. The result of applying the unscented transform to define a bounded

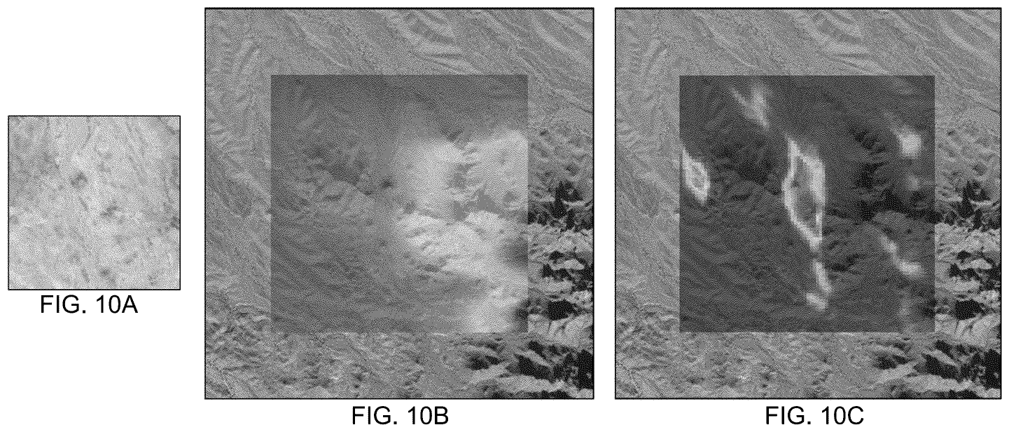

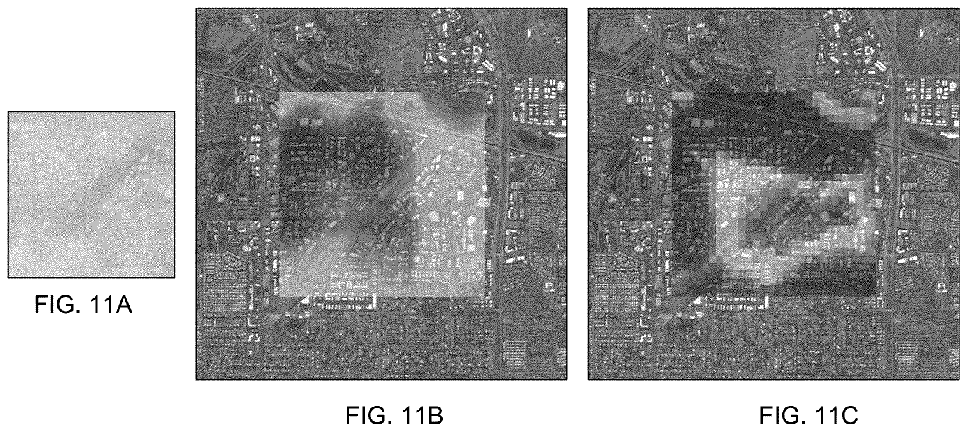

search area, then taking uniformly sampled queries about this search area to generate projections into the reference map and subsequent queries for the twin-network and construct a result heatmap is shown in FIGS. 10A-10C, and FIGS. 11A-11C. For these steps the following parameters were used to project a simulated camera of resolution 1024×1024 pixels, focal length of 3453 pixels, and principal point 512×512 pixels:

$$X = {[ \begin{matrix}X \\ Y \\ Z\end{matrix} ]}_{CRS} = {[ \begin{matrix}152941.92 \\ 232 250.88 \\ 10000\end{matrix} ]}_{meters}$$

And therefore the true camera state as projected onto the camera map is:

$$x = {[ \begin{matrix}X \\ Y\end{matrix} ]}_{CRS} = {[ \begin{matrix}152941.92 \\ 232 250.88\end{matrix} ]}_{meters}$$

The state estimate error e is defined as:

$$e = {[ \begin{matrix}250 \\ - 250\end{matrix} ]}_{CRS}$$

Making the simulated state estimate:

$$\hat{x} = x - e = {[ \begin{matrix}153191.92 \\ 232000.88\end{matrix} ]}_{CRS}$$

Assuming an X & Y coordinate covariance of σ=500 m, the resulting 30 unscented projection of nadir camera position estimate defines a search area of approximately 1500 m west, north, east, and south of \hat{x}, as shown in FIG. 10A. Grid query samples are then defined uniformly over this area in 50 m increments, of which every tenth sample is shown in FIG. 10B. Running the twin-network inference with the test input defined as the camera image projected from x onto the camera map, with all resulting query images via projections onto the reference map at each query location, results in the heatmap shown in FIG. 10C. Using the peak localization method we obtain:

$${y}_{peak} = {[ \begin{matrix}152761.28 \\ 232025.96\end{matrix} ]}_{CRS}$$

with a resulting a localization error:

$$x - {y}_{peak} = {[ \begin{matrix}180.64 \\ 224.93\end{matrix} ]}_{meters}$$

with magnitude 288.48 meters.

Using the moments localization method results in an improved localization estimate of:

$$y = {[ \begin{matrix}152858.98 \\ 232231.48\end{matrix} ]}_{CRS}$$

with a localization error of:

$$x - y = {[ \begin{matrix}82.94 \\ 19.4\end{matrix} ]}_{meters}$$

with magnitude 85.17 meters.

This localization measurement presents a reduction of error from the true camera state of approximately 177 meters compared to the camera state estimate, or approximately a 67.5% reduction in nadir position error. A visualization of this localization estimate, in conjunction with the camera nadir true state and state estimate is shown in FIG. 11B.

Various embodiments build upon the above-described embodiments. In some embodiments, UAV imagery is used in both the training and testing since matching UAV data to satellite imagery is more representative of the desired use-case. In some embodiments, changes to the network architecture are provided to optimize model fitment to the training data and improve generalizability. In some embodiments, training is performed to seek robustness to common non-ideal image differences between test and query images, including rotation errors due to heading estimate error. In some embodiments, standard neural network optimization strategies are employed such as hyperparameter optimization.

Various embodiments contemplate that the use of a downward facing camera (NADIR camera) may also comprise a multi-spectral camera and/or a synthetic aperture radar (SAR). In this manner, the various embodiments extend system use to all weather conditions, as well as day/night scenarios. Further, the NADIR camera and database imagery may contain various amounts and varieties of spectral and SAR data and the above-described matching steps may be modified to occur across these additional domains. This cross-domain matching may be useful when, for example, available satellite data does not utilize the same spectrum as the assets NADIR sensor. Thus, for example, the matching process whereby received images are matched to stored images may be performed for each of one or more spectral regions, such a visible/optical spectral region or portion thereof, an infrared or color-infrared spectral region or portion thereof, a radar-related spectral region or portion thereof, or some other electromagnetic spectrum region(s) or portion(s) thereof, and so on depending upon the availability of corresponding image data or image maps, and NADIR camera capability.

Various embodiments contemplate the addition/use of a navigation filter having an input comprising an inertial measurement unit (IMU) and an output comprising a state of the system including position data and uncertainties (e.g., error covariance) with that state value. Various embodiments may themselves be integrated into a navigation filter by providing as input geo-located points on the ground with the IMU data. One alternative use case comprises the system acting separately, wherein the system receives uses estimated position data, and uncertainties associated with the estimated position data via the state error covariance, to provide a position measurement comparable to a GPS measurement.

While the disclosure has been described with reference to exemplary embodiments, it will be understood by those skilled in the art that various changes may be made, and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure is not limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of a specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method for in-flight navigation for a high-altitude platform, the platform comprising a ground-facing camera and a computing device including a memory and a processor, the memory storing instructions which when processed cause the computing device to perform a position determination method, comprising:
acquiring one or more images from the ground-facing imaging device;
retrieving, from an image dataset associated with a trained model, a plurality images associated with an area of interest;
processing, using an image comparator, the acquired one or more images and the retrieved images associated with terrain of interest to derive therefrom respective acquired image feature sets;
using a loss function, comparing each acquired image feature set to each retrieved image feature set to identify for each acquired image a corresponding matching retrieved image;
using the matched image and the optical characteristics of the ground-facing camera, determining the position of the platform.

2. The method of claim 1, wherein the image comparator comprises a neural network.

3. The method of claim 1, wherein the image comparator comprises first and second convolutional neural networks (CNNs), each operating in a substantially similar manner to process, respectively, the acquired one or more images and the retrieved images associated with terrain of interest.

4. The method of claim 1, wherein the acquired images and retrieved images comprise infrared images.

5. The method of claim 1, wherein the acquired images and retrieved images comprise images above and below optical wavelengths.

6. The method of claim 1, further comprising:
prior to a flight of the high-altitude platform, defining within the stored image data a subset of image data associated with the flight; and
further processing the subset of image data according to an expected overflight terrain.

7. The method of claim 1, wherein:
the ground-facing imaging device is configured to acquire images in two spectral regions;
the retrieved images associated with terrain of interest comprise images associated with each of a first spectral region reference map and a second spectral region reference map;
each acquired image feature set associated with the first spectral region is compared to each retrieved image feature set from the first spectral region reference map; and
each acquired image feature set associated with the second spectral region is compared to each retrieved image feature set from the second spectral region reference map.

8. The method of claim 7, wherein determining the position of the platform is performed using the matched image and the optical characteristics of the ground-facing camera for each of the two spectral regions.

9. The method of claim 8, wherein determining the position of the platform comprises an average of determined positions of the platform performed using the matched image and the optical characteristics of the ground-facing camera for each of the two spectral regions.

10. The method of claim 7, wherein the first and second spectral regions comprise respective portions of visible, infrared, color-infrared, and ultraviolet spectral regions.

11. The method of claim 7, wherein the first and second spectral regions comprise respective portions of visible, infrared, color-infrared, ultraviolet, and radar-based measurement regions.

12. A platform configured for in-flight navigation and comprising a ground-facing camera and a computing device including a memory and a processor, the memory storing instructions which when processed cause the computing device to perform a position determination method, comprising:
acquiring one or more images from the ground-facing imaging device;
retrieving, from an image dataset associated with a trained model, a plurality images associated with an area of interest;
processing, using an image comparator, the acquired one or more images and the retrieved images associated with terrain of interest to derive therefrom respective acquired image feature sets;
using a loss function, comparing each acquired image feature set to each retrieved image feature set to identify for each acquired image a corresponding matching retrieved image;
using the matched image and the optical characteristics of the ground-facing camera, determining the position of the platform.

13. The platform of claim 12, wherein the image comparator comprises a neural network.

14. The platform of claim 12, wherein the image comparator comprises first and second convolutional neural networks (CNNs), each operating in a substantially similar manner to process, respectively, the acquired one or more images and the retrieved images associated with terrain of interest.

15. The platform of claim 12, wherein prior to a flight the platform having stored within the stored image data a subset of image data associated with the flight; and the method includes further processing the subset of image data according to an expected overflight terrain.

16. The platform of claim 12, wherein:
the ground-facing imaging device is configured to acquire images in two spectral regions;
the retrieved images associated with terrain of interest comprise images associated with each of a first spectral region reference map and a second spectral region reference map;
each acquired image feature set associated with the first spectral region is compared to each retrieved image feature set from the first spectral region reference map; and
each acquired image feature set associated with the second spectral region is compared to each retrieved image feature set from the second spectral region reference map.

17. The platform of claim 16, wherein determining the position of the platform is performed using the matched image and the optical characteristics of the ground-facing camera for each of the two spectral regions.

18. The platform of claim 16, wherein wherein determining the position of the platform comprises an average of determined positions of the platform performed using the matched image and the optical characteristics of the ground-facing camera for each of the two spectral regions.

19. The platform of claim 16, wherein the first and second spectral regions comprise respective portions of visible, infrared, color-infrared, and ultraviolet spectral regions.

20. The platform of claim 16, wherein the first and second spectral regions comprise respective portions of visible, infrared, color-infrared, ultraviolet, and radar-based sensing regions.
